(19) United States
(12) Patent Application Publication
(10) Pub. No.: US 2026/0220134 A1
(43) Pub. Date: Jul. 30, 2026

(54) STRUCTURED HYBRID RETRIEVAL AUGMENTED GENERATION

(71) Applicant: Rubrik, Inc., Palo Alto, CA (US)

(72) Inventors: Adam Gee, Menlo Park, CA (US); Nikita Awasthi, Sunnyvale, CA (US); Partha Dhar, Mountain View, CA (US)

(21) Appl. No.: 19/041,788

(22) Filed: Jan. 30, 2025

(51) Int. Cl. G06F 16/2453; G06F 16/22; G06F 16/2455

(52) U.S. Cl. CPC G06F 16/24534; G06F 16/2237; G06F 16/2455

(57) ABSTRACT

Methods, systems, and non-transitory computer readable media are configured to perform operations comprising: selecting, by a computing system, a dimension from data pairs associated with a document; determining, by the computing system, a chunk of the document to generate an embedding vector; and associating, by the computing system, the embedding vector with the dimension.

### FIELD OF THE INVENTION

The present technology relates to the field of generative artificial intelligence. More particularly, the present technology relates to optimization of retrieval augmented generation (RAG) techniques for various types of data.

### BACKGROUND

Retrieval augmented generation (RAG) is an artificial intelligence based technique that utilizes information retrieval to support language generation. For example, an organization implementing RAG can leverage relevant data from its knowledge base to optimize prompts provided to a large language model (LLM). Prompts constructed by the organization in this manner can support generation of responses by the LLM that are more relevant and accurate. The data maintained in the knowledge base can reflect different types of data.

### SUMMARY

Various embodiments of the present technology can include systems, methods, and non-transitory computer readable media configured to perform operations comprising: selecting, by a computing system, a dimension from data pairs associated with a document; determining, by the computing system, a chunk of the document to generate an embedding vector; and associating, by the computing system, the embedding vector with the dimension.

In some embodiments, the data pairs include key value pairs as structured data.

In some embodiments, the systems, methods, and non-transitory computer readable media are configured to perform further operations comprising: providing the embedding vector for storage in a vector database; and providing the dimension for storage in the vector database in association with the embedding vector.

In some embodiments, the dimension is in a metadata column of the vector database.

In some embodiments, the dimension is included in a set of dimensions determined based at least in part on a schema associated with a type of the document.

In some embodiments, the dimension is excluded from chunking of the document.

In some embodiments, the dimension and a second dimension are included in a nested hierarchy of dimensions associated with the document, the dimension is descriptive of the entirety of the document and the second dimension is descriptive of a portion of the document, a second embedding vector generated based on a second chunk of the portion of the document is associated with the dimension and the second dimension, and the embedding vector is not associated with the second dimension.

In some embodiments, the systems, methods, and non-transitory computer readable media are configured to perform further operations comprising: transforming a query into a query portion and a metadata filter portion; and causing a search of a vector database including the embedding vector based at least in part on the metadata filter portion.

In some embodiments, the transforming is performed by a large language model (LLM).

In some embodiments, the document is a type associated with a software-as-a-service (Saas) application, and the embedding vector and associated dimension are stored in a vector database supportive of a retrieval augmented generation (RAG) system.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example vector embedding system that optimizes transformation of structured data in a retrieval augmented generation (RAG) environment, according to an embodiment of the present technology.

FIG. 2 illustrates an example screen generated by an application or service, according to an embodiment of the present technology.

FIG. 3 illustrates an example document associated with an application or service, according to an embodiment of the present technology.

FIG. 4A illustrates an example diagram of selection of dimensions at a first level of a document, according to an embodiment of the present technology.

FIG. 4B illustrates an example diagram of selection of dimensions at a second level of a document, according to an embodiment of the present technology.

FIG. 5 illustrates an example diagram of stored embedding vectors and associated dimensions, according to an embodiment of the present technology.

FIG. 6 illustrates an example RAG management system, according to an embodiment of the present technology.

FIG. 7 illustrates a method, according to an embodiment of the present technology.

FIG. 8 illustrates an example of a computing environment in which a RAG management system can be implemented, according to an embodiment of the present technology.

FIG. 9 illustrates an example computer system, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Retrieval augmented generation (RAG) is an artificial intelligence based technique that utilizes information retrieval to support language generation. For example, an organization implementing RAG can leverage relevant data from its knowledge base to optimize prompts provided to a large language model (LLM). Prompts developed by the organization in this manner can support generation of responses by the LLM that are more relevant and accurate. The data maintained in the knowledge base can reflect different types of data.

Chunking can be utilized to process data from a knowledge base. Chunking can involve segmenting sometimes large amounts of data, such as documents including text, into relatively smaller units often referred to as “chunks”. A typical chunking technique can involve division of documents by, for example, sentences, paragraphs, or selected limits on character or token amounts. Embedding models can use machine learning techniques to convert chunks into embedding vectors that capture meaning from the content associated with the chunks. The embedding vectors can be maintained in a vector database. The size of each chunk can be determined based on a variety of considerations, such as desired granularity and constraints on the size of a prompt provided to an LLM. Embedding vectors stored in vector databases allow efficient and effective searching to find relevant information from a knowledge base for inclusion in prompts provided to an LLM.

Chunking of structured data often poses more challenges than chunking of unstructured data. Unstructured data, such as Word documents or the like, can have relatively large amounts of text. Such text can reflect natural organization of concepts or ideas as reflected in sequences or groupings of sentences, paragraphs, and other sections of a document. Thus, chunking of unstructured data that is consistent with such organization can reflect effective segmentation in which semantics are recognized and preserved in respective chunks.

In contrast, conventional chunking techniques when applied to structured data can result in myriad disadvantages. A document including structured data can be characterized by the use of labels, tags, keys, or other metadata that can be descriptive of corresponding portions or the entirety of the document. In some instances, structured data can be characterized as relational in nature and represented though a table in which column names correspond to labels and column entries correspond to associated values. In a conventional chunking technique, a chunk can contain a label and adjacent values or text according to chunk size specifications. Accordingly, the label is associated with only immediately surrounding information. When the label in reality is descriptive of more than the immediately surrounding information, the generation of other chunks associated with the surrounding information can lack descriptive information provided by the label. Accordingly, a search through a vector database of embedding vectors generated from such chunks can return results that are incomplete, inaccurate, or otherwise suboptimal.

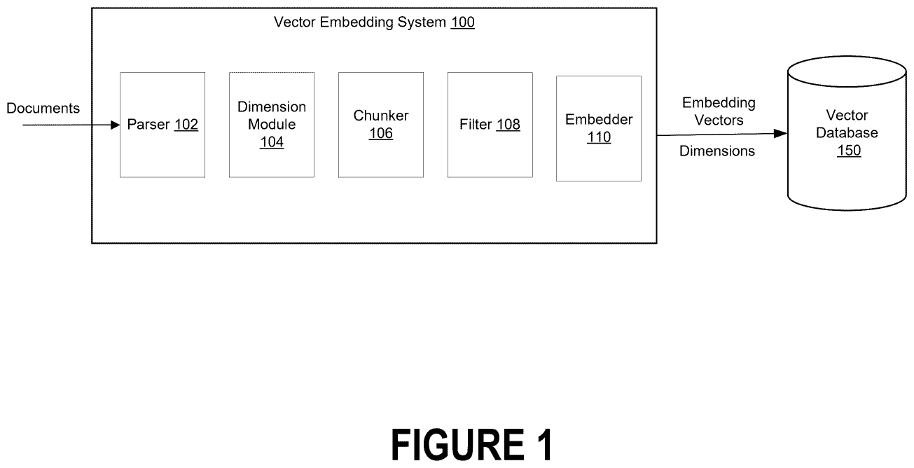

An improved approach rooted in computer technology overcomes the foregoing and other disadvantages associated with conventional approaches specifically arising in the realm of computer technology. FIG. 1 illustrates an example vector embedding system 100 that optimizes transformation of structured data in a retrieval augmented generation (RAG) environment, according to an embodiment of the present technology. The vector embedding system 100 allows for selection of certain dimensions from key-value pairs associated with structured data (or semi-structured data) of a document. The dimensions can constitute metadata for embedding vectors generated from chunks of data (e.g., unstructured data) of the document. Embedding vectors can be associated with their related dimensions in a vector database. The association of embedding vectors with relevant dimensions can optimize discovery and utilization of accurate and relevant information from a knowledge base in the RAG environment. More details about the present technology and its various embodiments are provided herein.

The vector embedding system 100 can acquire various types of data in different formats, including documents. In some cases, the documents can be included in or otherwise associated with snapshots of backup data of an organization. A document can be or include structured data or unstructured data. As used herein, structured data can be or include labels, tags, descriptors, keys, or other types of metadata of a document as well as a corresponding portion (e.g., value, section, etc.) or the entirety of the document associated with the metadata. For example, structured data can include metadata and a corresponding portion of a document that contains less than a threshold quantity of text. The threshold quantity of text can be utilized to identify structured data. In some instances, structured data can be predefined or predetermined based on the type of metadata. Structured data can be included in documents generated by software applications or services, such as software-as-a-service (Saas). Documents containing structured data can include, for example, documents generated from applications or services provided by organizations such as Amazon, Microsoft, Atlassian, Salesforce, Workday, Slack, etc. While many examples discussed herein reference structured data, the present technology can apply equally to semi-structured data. As used herein, unstructured data can be or include data that is free form or not structured (or not semi-structured). Unstructured data can be included in documents containing substantial amounts of text without associated metadata. For example, unstructured data can include an amount of text without associated metadata that is greater than or equal to a threshold quantity of text. The threshold quantity of text can be utilized to identify unstructured data. In various embodiments, the threshold quantity of text utilized to identify unstructured data can be the same as or different from the threshold quantity of text utilized to identify structured data. Documents containing unstructured data can include, for example, documents generated from software applications such as Word, Acrobat, Google Docs, etc.

A document can be provided to a parser 102 of the vector embedding system 100. For a document including structured data, the parser 102 can extract metadata, such as a key, and a portion or entirety of a document associated with the metadata, such a value. As used herein, the extracted information can be referred to as key-value pairs. While key-value pairs are referenced herein in various examples, the term “key-value pair” is intended to encompass and include contexts involving other types of data pairs including, for example, attribute-value pairs, name-value pairs, field-value pairs, property-value pairs, index-value pairs, and the like. The parser 102 can operate on the document to extract all key-value pairs in the document. The parser 102 can utilize a parsing technique or strategy that is suitable to extract key-value pairs for different types of documents including structured data. In some embodiments, the parser 102 can apply a parsing technique suitable for JSON. In some embodiments, the parser 102 can apply a parsing technique for other types or expressions of key-value pairs. Accordingly, the parser 102 can be or include a JSON parser, an XML parser, a CSV parser, HTML parser, and the like.

In some embodiments, key-value pairs from a document including structured data can be represented as relational data maintained in one or more tables. For example, the key-value pairs at a top level of the document can be reflected in a top-level or first table having columns for the keys and rows for the values; key-value pairs at a second level of the document can be referenced in the first table and reflected in a second level table; key value pairs at a third level of the document can be referenced in the second table and reflected in a third level table; and so on. Accordingly, the parser 102 can determine key-value pairs of the document as well as their nested hierarchical relationships based on tables representative of the document.

A dimension module 104 can select certain key-value pairs of a document as dimensions. A dimension can refer to a selected or predetermined key-value pair that is descriptive of or otherwise associated with one or more portions, or the entirety, of a document, such as unstructured data of the document. Selection of dimensions relating to a document can be based on a variety of considerations. In some embodiments, the selection of dimensions can be based in part on a schema of the document that defines or describes the structure (e.g., hierarchical or nested arrangement), data types (e.g., strings, numbers, boolean, etc.), and constraints (e.g., value ranges, required fields, certain formats, etc.) of data in the document. For example, key-value pairs (or fields) of certain data types (e.g., boolean) or subject to certain constraints (e.g., a field length limitation) can be identified as structured data instead of unstructured data and thus potentially selected as dimensions. In some embodiments, the selection of dimensions can be based in part on a type of the document. For example, the vector embedding system 100 can accumulate data regarding key-value pairs that frequently appear in or are characteristic of a particular type of document. Certain key-value pairs suitable for selection as dimensions for the type of document can be determined. For instance, if a key-value pair consistently appears in a document of a particular type, the key-value pair can be selected as a dimension for chunks relating to associated unstructured data of the document. The dimension module 104 can remove dimensions of a document from chunking of the document. As discussed in more detail, a dimension can be maintained in a vector database alongside an embedding vector corresponding to a chunk of a document associated with the dimension.

The dimension module 104 can determine associations between dimensions of a document and chunks of the document. A structure of a document can have a plurality of levels in a hierarchy. A dimension can be hierarchically associated with embedding vectors corresponding to chunks relating to data, such as unstructured data, of the document at one or more levels of the document. In some embodiments, a dimension at a particular level of a document can be associated with embedding vectors corresponding to chunks relating to unstructured data at the particular level and all levels below the particular level. In some embodiments, a dimension at a given level of a document is not associated with embedding vectors corresponding to chunks of unstructured data at levels that are higher than the given level. For example, a dimension at a top, first level (e.g., parent level) of a document having a plurality of levels can be associated with an embedding vector corresponding to a chunk of unstructured data at the first level. Further, the dimension at the first level can be associated with embedding vectors corresponding to chunks of unstructured data at one or more, or all, levels (e.g., child levels) that are below the first level. As another example, a dimension at the second level can be associated with embedding vectors corresponding to chunks of unstructured data at the second level and levels below the second level. In this example, the dimension at the second level is not associated with embedding vectors corresponding to chunks of unstructured data at the first level. As yet another example, a dimension at a third level can be associated with embedding vectors corresponding to chunks of unstructured data at the third level and levels below the third level. In this example, the dimension at the third level is not associated with embedding vectors corresponding to chunks of unstructured data at the first level and the second level. The foregoing examples are merely illustrations and many variations are possible. While some examples discussed herein reference chunks of unstructured data, the present technology in some embodiments can also apply to chunks of data including structured data and excluding dimensions.

A chunker 106 of the vector embedding system 100 can receive a stream of data of a document to segment suitable portions of the document into chunks. A chunk can constitute a selected segment (or entirety) of the document. Chunking can be performed according to various strategies based on myriad factors. The factors can include, for example, document structure, chunk size, context preservation, retrieval efficiency, generation performance, and application specific requirements. As just one example, a desired granularity or chunk size can be a factor in determination of a suitable chunking strategy. One consideration can be, for example, predetermined token limits on the length of a prompt provided to an LLM. Other competing considerations can be, for example, that smaller chunks can omit contextual information for a given query of a vector database while large chunks can obscure relevant information. These and other considerations can inform determination of a suitable chunking strategy for a document.

In some embodiments, dimensions of the document are not provided to the chunker 106 and thus are not chunked. Data to be chunked by the chunker 106 can include unstructured data of the document. In some embodiments, data to be chunked by the chunker 106 can include structured data and exclude dimensions. In some instances, a key or other metadata can be associated with a segment of unstructured data. In some embodiments, when unstructured data is to be segmented into one or more chunks, metadata associated with the unstructured data can be embedded into each chunk. For example, a key of a document can be “Summary” and a corresponding value can be a given number of paragraphs that summarize the document. In this example, if the size of a chunk is configured to be a paragraph length, a chunk can be generated for each paragraph and “Summary” can be embedded in each paragraph. In some embodiments, the data to be chunked can include key-value pairs of the document that have not been selected as dimensions of the document.

A filter 108 of the vector embedding system 100 can exclude sensitive data from chunking and thus prevent access to the sensitive data through a vector database supporting the RAG environment. Sensitive data can include, for example, personally identifiable information (PII), protected health information (PHI), financial data, intellectual property, and the like. For example, sensitive data can be identified from various types of documents, such as documents generated through applications and services (e.g., SaaS). As another example, sensitive data can be identified from scans of various types of data, such as virtual machines, physical servers, cloud environments, and the like. Sensitive data can be classified based on various techniques, such as machine learning and pattern recognition. Based on security preferences or rules for a given implementation, the filter 108 can be configured to withhold or otherwise remove selected types of sensitive data from chunking. As a result, embedding vectors of the sensitive data are not generated. Accordingly, the sensitive data is not available for inclusion in prompts provided to an LLM and is not otherwise accessible in a RAG environment.

An embedder 110 of the vector embedding system 100 can generate embedding vectors from chunks of a document. The embedder 110 can transform data, such as unstructured data (e.g., text data), in a chunk into a dense, mathematical vector representation or embedding vector. Embedding vectors can capture semantic meaning and relationships reflected in corresponding chunks. Embedding vectors can be generated whereby chunks with relatively similar meaning have relatively close embedding vectors in an embedding space while chunks with relatively different meaning have relatively distant embedding vectors in the embedding space. The embedder 110 can utilize any suitable embedding model. An embedding model can be or include, for example, Bidirectional Encoder Representations from Transformers (BERT), sentence BERT (SBERT), RoBERTa, Word2vec, Ada, Curie, etc. Transformation of chunks into embedding vectors can enable efficient, effective provision and retrieval of information to and from a vector database supportive of a RAG environment.

Embedding vectors generated from chunks of a document can be provided to a vector database 150. The vector database 150 can maintain embedding vectors for retrieval in a RAG environment. The vector database 150 can be searched to access relevant information from a knowledge base for inclusion in a prompt to generate a response from an LLM. The vector database 150 can be any suitable vector database. A vector database can be or include, for example, Pinecone, Azure AI Search, Milvus, etc. In some embodiments, the vector database 150 can be maintained by an entity in control of the vector embedding system 100 or a different entity.

Dimensions of a document also can be provided to the vector database 150. As discussed, embedding vectors generated from chunks of a document can be stored in the vector database 150. Dimensions associated with the chunks can be stored in the vector database 150. In the vector database 150, the dimensions can be associated with the embedding vectors generated from the chunks. In some embodiments, an embedding vector can be stored in a column of a table maintained in the vector database 150 and one or more dimensions associated with the embedding vector can be stored in an adjacent column (e.g., metadata column). In the vector database 150, an embedding vector can be associated with one or more dimensions at one or more levels of a document. For example, an embedding vector associated with a chunk at a second level of a document can be associated with dimensions at the first level and dimensions at the second level of the document. The association of relevant dimensions with an associated embedding vector in the vector database 150 can improve the retrieval of accurate and relevant embedding vectors from the vector database 150, as discussed herein. In the database 150, for a dimension at a given level, embedding vectors corresponding to chunks at levels higher than the given level are not associated with the dimension.

The vector embedding system 100 can provide various types of data to be maintained in the vector database 150 or other databases. For example, metadata can be associated with an embedding vector. The metadata associated with an embedding vector can be metadata regarding the chunk from which the embedding vector was generated. The metadata can include, for example, a timestamp associated the data from which the chunk was taken, an identifier of the data, a computing system associated with the data, or other types of metadata. In some instances, metadata associated with an embedding vector can be maintained with the embedding vector in the database 150. In some instances, metadata associated with an embedding vector can be stored in a database other than the database 150 and, for each maintained embedding vector, the database 150 can maintain a pointer to the associated metadata. As another example, a chunk associated with an embedding vector can be stored in a database. In some instances, chunks associated with embedding vectors can be stored in the database 150. In some instances, chunks associated with embedding vectors can be stored in a database other than the database 150 and, for each maintained embedding vector, the database 150 can maintain a pointer to the corresponding chunk. As yet another example, a mapping log can be maintained by the database 150 or another database. The mapping log can include information that provides the storage location of chunks and metadata associated with embedding vectors. Many variations are possible.

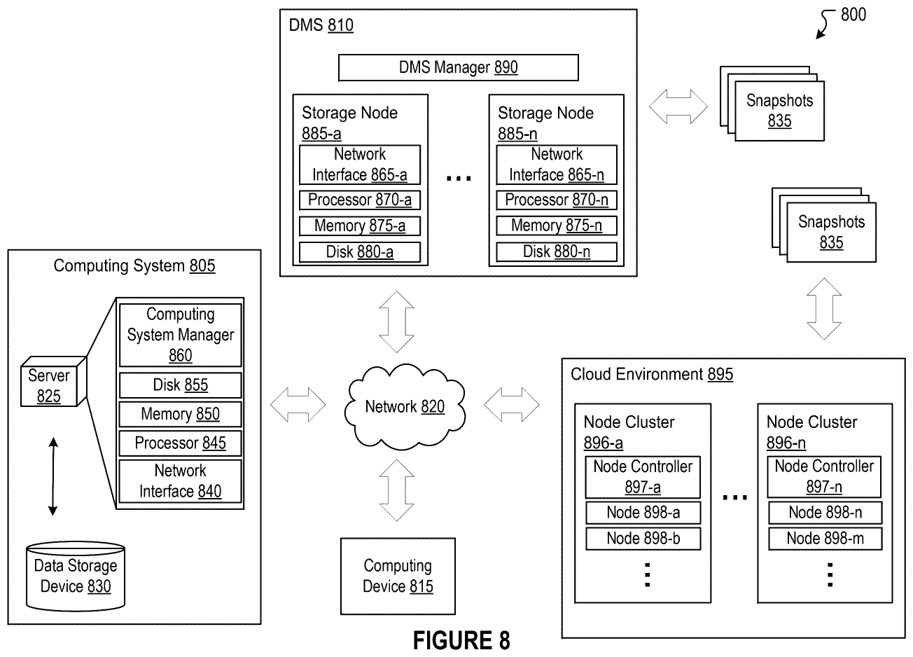

In some embodiments, the vector embedding system 100 and a RAG management system 600 as discussed below can be implemented by or in a data management service (DMS) 810 as described in connection with FIG. 8. For example, the data management service 810 can provide a data backup service, a data recovery service, a data classification service, a data transfer or replication service, and the like for its users (e.g., customers). In addition, the data management service 810 can provide an artificial intelligence (AI) assisted generative data service, such as provision of communication services (e.g., chatbot) for its users. Data managed by the data management service 810, such as backup data, can be utilized as content or a knowledge base for provision of any types of services in a RAG environment. Although the present technology is sometimes herein described in relation to a RAG environment, the present technology in some embodiments can be implemented in a variety of different environments and contexts apart from RAG.

The present technology, which can include the components and features (e.g., modules, elements, databases, functionalities, operations, etc.) discussed or shown in figures herein, can have many variations. Different implementations of the present technology may include additional, fewer, integrated, or different components and features. Some components or features may not be shown so as not to obscure relevant details. In various embodiments, one or more of the components and features described herein can be implemented in any suitable combinations.

In some instances, one entity (e.g., organization) can control, operate, maintain, or provide all of the components and features of the present technology. In some instances, one entity can control, operate, maintain, or provide some of the components and features of the present technology while one or more other entities can control, operate, maintain, or provide other of the components and features. In some instances, some or all components and features of the present technology can be implemented in a cloud environment. In some instances, some or all components and features of the present technology can be implemented on-premises. In some instances, the present technology can be implemented by a server system. In some embodiments, the functionality of the present technology can be distributed between a server system and an application running on a client computing device. Many variations are possible.

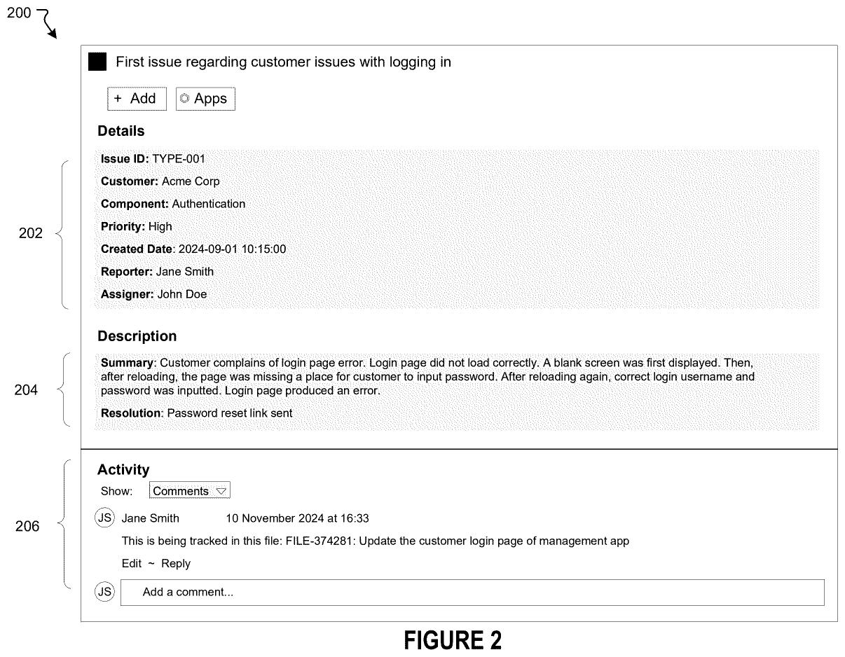

FIGS. 2-5 illustrate dimensions generated from a document and stored in a vector database, according to an embodiment of the present technology. FIG. 2 illustrates an example screen (or page) 200 generated by an application or service, according to an embodiment of the present technology. The screen 200 can be characteristic of a particular type of application or service. For example, the screen 200 can be generated by a provider of a SaaS application. The screen 200 can be included in a knowledge base in a RAG environment. For example, the screen 200 can be included in a snapshot of backup data of an organization utilizing the RAG environment.

In this example, the screen 200 can relate to a project in which issues have arisen. The screen 200 can include structured data and unstructured data. The screen 200 can include a section 202 containing structured data. As shown, the structured data in the section 202 can include an identifier for a title describing the issue, an issue ID, a customer affected by the issue, a component affected by the issue, a priority level of the issue, a date the issue was created, a person who reported the issue, and a person assigned to handle the issue. The screen 200 also can include a section 204 containing unstructured data. As shown, the unstructured data in the section 204 can include a summary of the issue and a resolution for the issue. In addition, the screen 200 can include a section 206 containing structured data and unstructured data relating to a comment about the issue. The screen 200 is merely an example. In other examples, other types of screens, files, or collections of data can include other types of structured data and unstructured data.

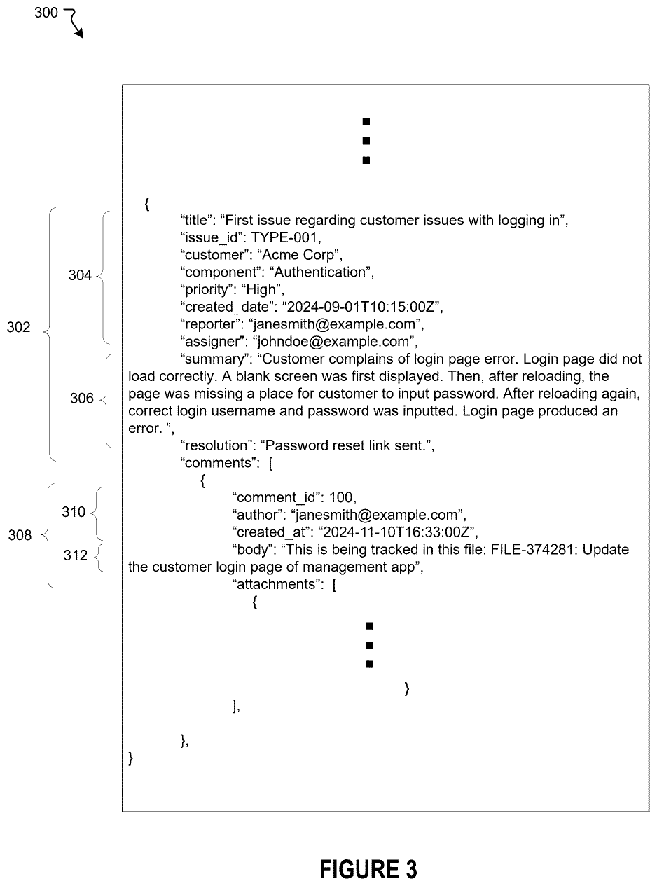

FIG. 3 illustrates an example document 300 associated with an application or service, according to an embodiment of the present technology. In particular, the document 300 can be an excerpt of a larger document corresponding to the screen 200. In the example shown, the document 300 reflects JSON including key-value pairs. In other examples, the document 300 can reflect other formats for expression of key-value pairs (e.g., XML, CSV, YAML, etc.). A first level 302 of the document 300 can include key-value pairs corresponding to structured data 304 and unstructured data 306. As shown, the structured data 304 can include key-value pairs relating to a title describing the issue, an identifier for an issue, a customer affected by the issue, a component affected by the issue, a priority level of the issue, a date and time the issue was created, a person who reported the issue, and a person assigned to handle the issue. The unstructured data 306 can include key-value pairs relating to a summary of the issue and a resolution for the issue. A second level 308 of the document 300 can include key-value pairs corresponding to structured data 310 and unstructured data 312 regarding a comment about the issue. As shown, the structured data 310 can include key-value pairs relating to an identifier for the comment, an author of the comment, and a date and time the comment was created. The unstructured data 312 can include a key-value pair relating to a text body of the comment. The key-value pairs in the document 300 are merely examples, and other key-value pairs are possible. The document 300 can be parsed. In some embodiments, the document 300 can be parsed by the parser 102.

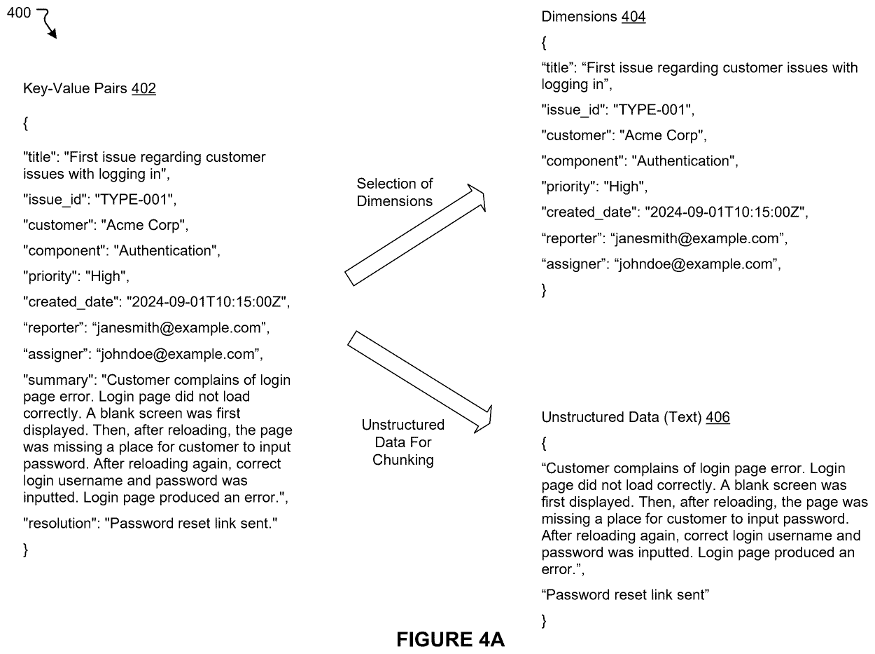

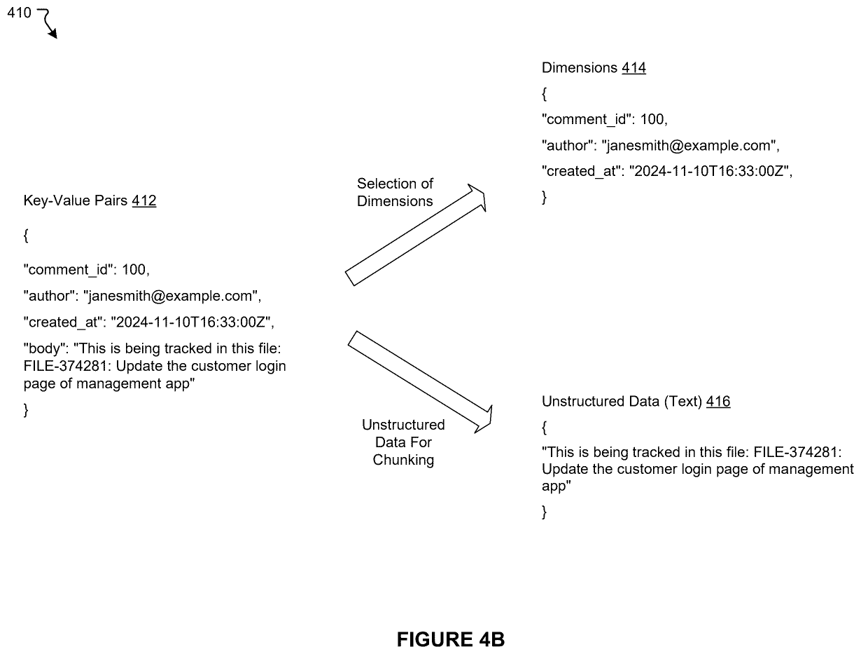

FIG. 4A illustrates an example diagram 400 of selection of dimensions at a first level of a document, according to an embodiment of the present technology. The diagram 400 illustrates determination of dimensions of the document 300. Key-value pairs 402 at the first level of the document 300 are shown. From the key-value pairs 402, dimensions 404 at the first level can be selected. As discussed, the selection of the dimensions 404 from the key-value pairs 402 can be based on, for example, a schema associated with document 300 and the type of the document 300. In some embodiments, the dimensions 404 can be generated by the dimension module 104.

From the key value pairs 402, unstructured data 406 at the first level can be determined. As discussed, chunks can be generated from the unstructured data 406. In some embodiments, the chunks can be generated by the chunker 106. As discussed, data that is sensitive can be removed from the chunking process. In some embodiments, removal of sensitive data in this manner can be performed by the filter 108. As discussed, based on a suitable embedding model, each chunk can be transformed into an embedding vector. In some embodiments, the transformation of a chunk into an embedding vector can be performed by the embedder 110. The dimensions 404 at the first level can be associated with each embedding vector generated from a chunk associated with the first level. Each such embedding vector, the corresponding dimensions 404, and the association between the embedding vector and the corresponding dimensions 404 can be stored in a vector database, such as the vector database 150.

FIG. 4B illustrates an example diagram 410 of selection of dimensions at a second level of a document, according to an embodiment of the present technology. The diagram 410 illustrates determination of dimensions of the document 300. Key-value pairs 412 at the second level of the document 300 are shown. From the key-value pairs 412, dimensions 414 at the second level can be selected in a manner as described above. As discussed, each embedding vector generated from a chunk associated with the second level can be associated with the dimensions 414 at the second level as well as the dimensions 404 at the first level. Each such embedding vector, the corresponding dimensions 414 and the dimensions 404, and the association between the embedding vector and the corresponding dimensions 414 and the dimensions 404 can be stored in a vector database, such as the vector database 150.

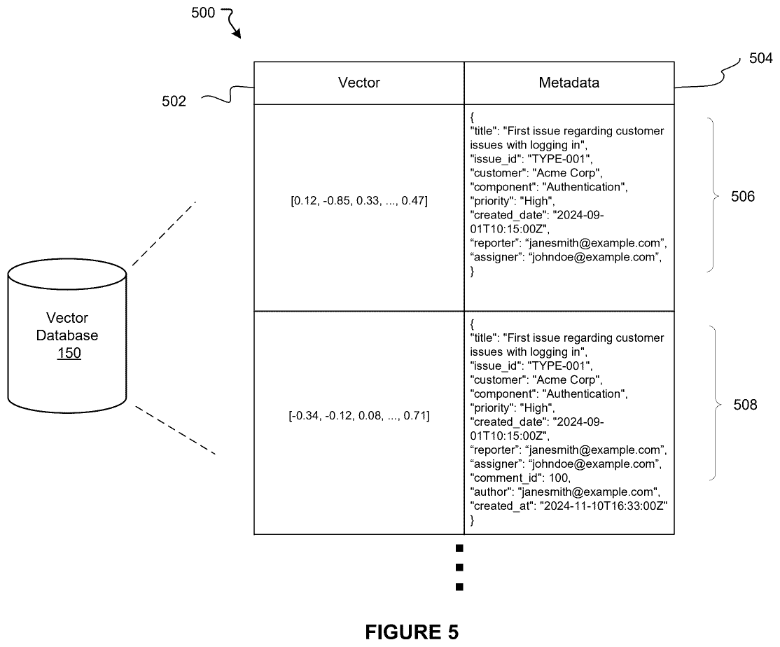

FIG. 5 illustrates an example diagram of stored embedding vectors and associated dimensions, according to an embodiment of the present technology. A database, such as the vector database 150, can store embedding vectors generated from chunks of data of the document 300. Each embedding vector can be stored with its associated dimensions in the vector database 150. For purposes of explanation, a table-like structure 500 is shown to conceptually illustrate the association of embedding vectors and associated dimensions. In some embodiments, the table-like structure 500 can reflect a search index of the vector database 150 that reflects embedding vectors and their associated dimensions. The table-like structure 500 can include a column 502 associated with embedding vectors and a column 504 associated with metadata. An embedding vector represented in row 506 can be generated from a chunk of unstructured data (e.g., summary of the issue) at the first level of the document 300. Accordingly, the embedding vector represented in row 506 is associated with dimensions at the first level, as shown in column 504. An embedding vector represented in row 508 can be generated from a chunk of unstructured data (e.g., text body of comment) at the second level of the document 300. Accordingly, the embedding vector represented in row 508 can be associated with dimensions at the second level and dimensions at the first level, as shown in column 504. The foregoing are merely examples. In other examples, embedding vectors generated from chunks of unstructured data at a given level (e.g., third level, fourth level, etc.) can be likewise associated with dimensions at the given level and all higher levels.

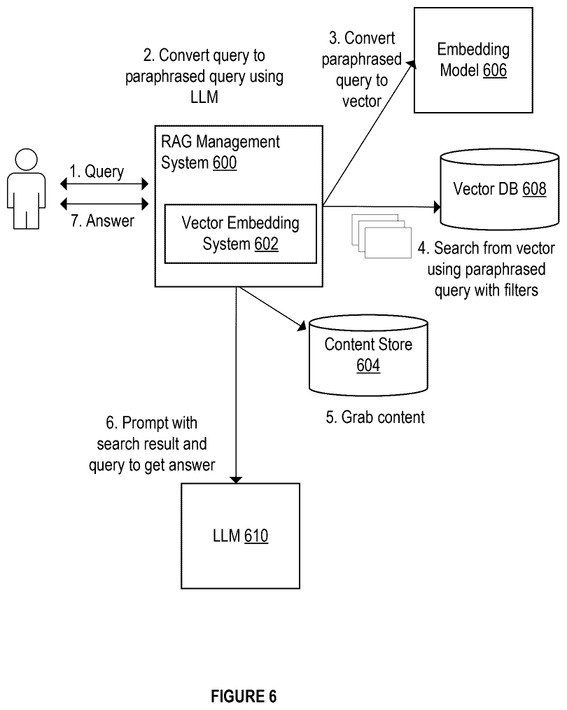

FIG. 6 illustrates an example RAG management system 600, according to an embodiment of the present technology. The RAG management system 600 can include a vector embedding system 602. In some embodiments, the vector embedding system 602 can be implemented by or perform the functions of the vector embedding system 100. The RAG management system 600 can be associated with a content store 604, an embedding model 606, a vector database 608, and a large language model (LLM) 610.

The content store 604 can contain data that constitutes a knowledge base or repository. The knowledge base can be a compilation of data associated with an organization. In some instances, the knowledge base can include proprietary information of the organization. In some instances, the data in the knowledge base can include documents of various types. For example, as discussed, the documents can be generated by a particular type of application or service (e.g., SaaS). The data in the knowledge base can be used to retrieve relevant, accurate information to optimize a prompt to be provided to the LLM 610.

Chunks of the data can be provided to the embedding model 606 to generate embedding vectors representative of the data. The chunks can be taken from unstructured data, such as text of documents, and structured data in the knowledge base. In some instances, data from which chunks can be generated can include, for example, documents, files, records, images, videos, etc. The embedding model 606 can be any suitable embedding model, such as an embedding model utilized by the embedder 110. The embedding model 606 can generate embedding vectors that are representative of the meaning or semantics of corresponding chunks.

The RAG management system 600 can cause embedding vectors to be stored in the vector database 608. The vector database 608 can be any suitable vector database, as referenced herein. As discussed, one or more dimensions associated with an embedding vector can be stored alongside the embedding vector in the vector database 608. In some instances, the vector database 608 can be external to the RAG management system 600 or cloud environment in which the RAG management system 600 may reside.

As shown in FIG. 6, the RAG management system 600 can facilitate automated communications with a user. The communications can be supported by an application, such as a communication application (e.g., chatbot), through which query responses generated by the LLM 610 can be returned to the user. In some embodiments, the communication application can be provided or maintained by the RAG management system 600. In some embodiments, the communication application can be provided or maintained by, for example, a customer of the entity in control of the RAG management system 600. As shown, the user can submit a query through the communication application. The query can be received by the RAG management system 600.

Then, the RAG management system 600 can transform the query into two parts. A first part can include filters reflected in the query. The filters can be applied to a search index associated with the vector database 608 to optimize or refine a search of the vector database 608. A second part can include a paraphrase of the query without the filters. For example, assume the user enters the following query: “List all the Acme Software bugs?” In this example, the RAG management system 600 can break down the query into a first part of “component=Acme Software” and a second part of “List all the bugs?”. The conversion of a query into two parts can be performed through a variety of techniques. In some embodiments, the conversion of a query can be performed by an LLM through a suitable prompt. For example, the prompt can include an instruction to convert the query into the two parts. As another example, the prompt additionally can include one or more examples of other queries that have been duly converted into two parts (e.g., one-shot prompt, few-shot prompt). As yet another example, the prompt additionally can include constraints for the LLM to select filters from a query from a set of predetermined filters that correspond to dimensions characteristic of a type of document associated with the query. As a further example, the prompt additionally can include specification of a desired output format, such as an expression of filters that is consistent with requirements of the vector database 608. In some embodiments, an LLM can be fine tuned to convert queries into two parts. For example, a training example to fine tune the LLM can include a query, filters extracted from the query, and a paraphrase of the query. In some embodiments, the LLM utilized to convert the query into two parts can be the LLM 610 or a different LLM. Many variations are possible.

Then, the RAG management system 600 can cause the paraphrased query to be converted into an embedding vector based on the embedding model 606. Then, the RAG management system 600 can cause performance of a search of the vector database 608 based on the embedding vector representative of the paraphrased query and subject to the filters determined from the query. The filters can be compared or matched with dimensions associated with embedding vectors that are stored in the vector database 608. The filters can be applied to a search index associated with the vector database 608 to refine and optimize the search. Various metadata filters (e.g., equality ($eq), inequality ($ne), greater than or equal ($gte), in ($in), exists ($exists), logical AND ($and), etc.) can be available and applied to formulate the search. The search of the vector database 608 can result in retrieval of embedding vectors stored in the vector database 608 that are most related or similar to the embedding vector representative of the query subject to the applicable filters.

Then, based on pointers associated with the identified embedding vectors, the RAG management system 600 can access the associated data (or text) from the content store 604. The data can be included in a prompt as contextual or relevant information to complement the query. Then, the prompt can be provided to the LLM 610 to elicit a response. In some embodiments, the LLM 610 can be replaced by or supplemented with any type of model capable of performing the functionality described herein, including but not limited to generating a response to a prompt and converting a query into two parts, as discussed. The model can be or include any type of generative AI model or foundation model, such as a multimodal model, a generative adversarial network (GAN), a variational autoencoder (VAE), an autoregressive model, a transformer based model, etc. As just one example, the model can be capable of performing general purpose language generation and other natural language processing tasks associated with artificial intelligence. The model can be pretrained based on vast amounts of textual data and deep learning techniques. The model can be proprietary or source available. The model can be maintained on the premises of an organization in control of the RAG management system 600 or utilized by the RAG management system 600 as a service hosted by another organization. Many variations are possible. Then, the RAG management system 600 through the communication application can provide the response to the user.

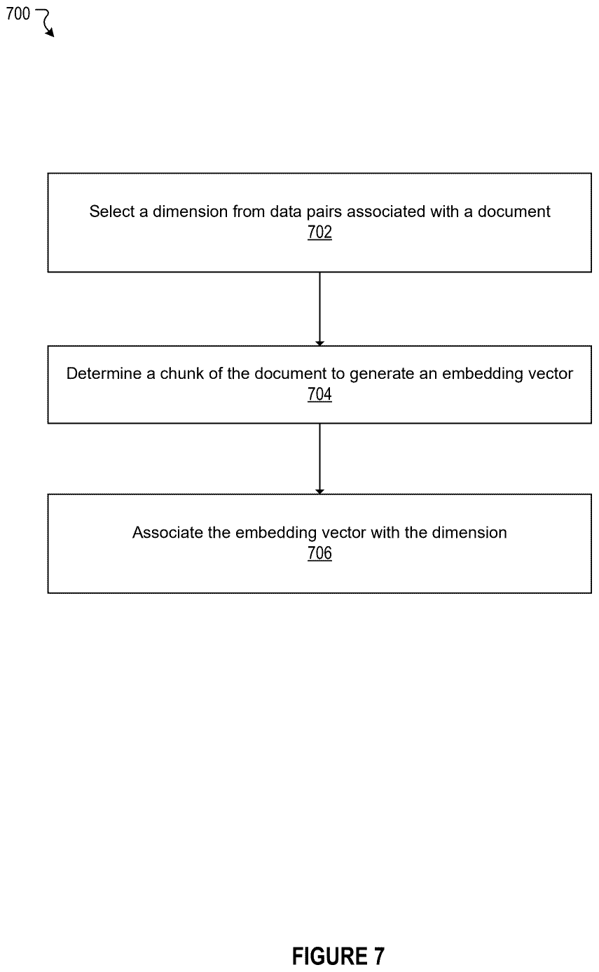

FIG. 7 illustrates an example method relating to association of an embedding vector with a dimension, according to an embodiment of the present technology. It should be understood that there can be additional, fewer, or alternative steps performed in similar or alternative orders, or in parallel, based on the various features and embodiments discussed herein unless otherwise stated. At block 702, the method 700 can select a dimension from data pairs parsed from a document. At block 704, the method 700 can determine a chunk of the document to generate an embedding vector. At block 706, the method 700 can associate the embedding vector with the dimension.

FIG. 8 illustrates an example of a computing environment 800 in which the RAG management system 600 can be implemented in accordance with the present technology. The computing environment 800 may include a computing system 805, a data management service (DMS) 810, and one or more computing devices 815, which may be in communication with one another via a network 820. The computing system 805 may generate, store, process, modify, or otherwise use associated data, and the DMS 810 may provide one or more data management services for the computing system 805. For example, the DMS 810 may provide a data backup service, a data recovery service, a data classification service, a data transfer or replication service, a malware protection service, a sensitive data classification service, and an artificial intelligence (AI) assisted generative data service. For example, the AI assisted generative data service can support chatbot services empowering users of the DMS 810 to ask questions, troubleshoot problems, or initiate workflows.

The network 820 may allow the one or more computing devices 815, the computing system 805, and the DMS 810 to communicate (e.g., exchange information) with one another. The network 820 may include aspects of one or more wired networks (e.g., the Internet), one or more wireless networks (e.g., cellular networks), or any combination thereof. The network 820 may include aspects of one or more public networks or private networks, as well as secured or unsecured networks, or any combination thereof. The network 820 also may include any quantity of communications links and any quantity of hubs, bridges, routers, switches, ports or other physical or logical network components.

A computing device 815 may be used to input information to or receive information from the computing system 805, the DMS 810, or both. For example, a user of the computing device 815 may provide user inputs via the computing device 815, which may result in commands, data, or any combination thereof being communicated via the network 820 to the computing system 805, the DMS 810, or both. Additionally, or alternatively, a computing device 815 may output (e.g., display) data or other information received from the computing system 805, the DMS 810, or both. A user of a computing device 815 may, for example, use the computing device 815 to interact with one or more Uls (e.g., graphical user interfaces (GUIs)) to operate or otherwise interact with the computing system 805, the DMS 810, or both. Though one computing device 815 is shown in FIG. 8, it is to be understood that the computing environment 800 may include any quantity of computing devices 815.

A computing device 815 may be a stationary device (e.g., a desktop computer or access point) or a mobile device (e.g., a laptop computer, tablet computer, or cellular phone). In some examples, a computing device 815 may be a commercial computing device, such as a server or collection of servers. And in some examples, a computing device 815 may be a virtual device (e.g., a virtual machine). Though shown as a separate device in the example computing environment of FIG. 8, it is to be understood that in some cases a computing device 815 may be included in (e.g., may be a component of) the computing system 805 or the DMS 810.

The computing system 805 may include one or more servers 825 and may provide (e.g., to the one or more computing devices 815) local or remote access to applications, databases, or files stored within the computing system 805. The computing system 805 may further include one or more data storage devices 830. Though one server 825 and one data storage device 830 are shown in FIG. 8, it is to be understood that the computing system 805 may include any quantity of servers 825 and any quantity of data storage devices 830, which may be in communication with one another and collectively perform one or more functions ascribed herein to the server 825 and data storage device 830.

A data storage device 830 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 830 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 830 may be a database (e.g., a relational database), and a server 825 may host (e.g., provide a database management system for) the database.

A server 825 may allow a client (e.g., a computing device 815) to download information or files (e.g., executable, text, application, audio, image, or video files) from the computing system 805, to upload such information or files to the computing system 805, or to perform a search related to particular information stored by the computing system 805. In some examples, a server 825 may act as an application server or a file server. In general, a server 825 may refer to one or more hardware devices that act as the host in a client-server relationship or a software process that shares a resource with or performs work for one or more clients.

A server 825 may include a network interface 840, processor 845, memory 850, disk 855, and computing system manager 860. The network interface 840 may enable the server 825 to connect to and exchange information via the network 820 (e.g., using one or more network protocols). The network interface 840 may include one or more wireless network interfaces, one or more wired network interfaces, or any combination thereof. The processor 845 may execute computer-readable instructions stored in the memory 850 in order to cause the server 825 to perform functions ascribed herein to the server 825. The processor 845 may include one or more processing units, such as one or more central processing units (CPUs), one or more graphics processing units (GPUs), or any combination thereof. The memory 850 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 855 may include one or more HDDs, one or more SSDs, or any combination thereof. Memory 850 and disk 855 may comprise hardware storage devices. The computing system manager 860 may manage the computing system 805 or aspects thereof (e.g., based on instructions stored in the memory 850 and executed by the processor 845) to perform functions ascribed herein to the computing system 805. In some examples, the network interface 840, processor 845, memory 850, and disk 855 may be included in a hardware layer of a server 825, and the computing system manager 860 may be included in a software layer of the server 825. In some cases, the computing system manager 860 may be distributed across (e.g., implemented by) multiple servers 825 within the computing system 805.

In some examples, the computing system 805 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 805 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 815 over the network 820). IaaS may refer to a service in which physical computing resources are used to instantiate one or more virtual machines, the resources of which are made available to one or more client devices over a network (e.g., to one or more computing devices 815 over the network 820).

In some examples, the computing system 805 or aspects thereof may implement or be implemented by one or more virtual machines. The one or more virtual machines may run various applications, such as a database server, an application server, or a web server. For example, a server 825 may be used to host (e.g., create, manage) one or more virtual machines, and the computing system manager 860 may manage a virtualized infrastructure within the computing system 805 and perform management operations associated with the virtualized infrastructure. The computing system manager 860 may manage the provisioning of virtual machines running within the virtualized infrastructure and provide an interface to a computing device 815 interacting with the virtualized infrastructure. For example, the computing system manager 860 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 855, the memory, the processor 845, the network interface 840, the data storage device 830, or any combination thereof in support of running the various applications. Storage resources (e.g., the disk 855, the memory 850, or the data storage device 830) that are virtualized may be accessed by applications as a virtual disk.

The DMS 810 may provide one or more data management services for data associated with the computing system 805 and may include DMS manager 890 and any quantity of storage nodes 885. The DMS manager 890 may manage operation of the DMS 810, including the storage nodes 885. Though illustrated as a separate entity within the DMS 810, the DMS manager 890 may in some cases be implemented (e.g., as a software application) by one or more of the storage nodes 885. In some examples, the storage nodes 885 may be included in a hardware layer of the DMS 810, and the DMS manager 890 may be included in a software layer of the DMS 810. In the example illustrated in FIG. 8, the DMS 810 is separate from the computing system 805 but in communication with the computing system 805 via the network 820. It is to be understood, however, that in some examples at least some aspects of the DMS 810 may be located within computing system 805. For example, one or more servers 825, one or more data storage devices 830, and at least some aspects of the DMS 810 may be implemented within the same cloud environment or within the same data center.

Storage nodes 885 of the DMS 810 may include respective network interfaces 865, processors 870, memories 875, and disks 880. The network interfaces 865 may enable the storage nodes 885 to connect to one another, to the network 820, or both. A network interface 865 may include one or more wireless network interfaces, one or more wired network interfaces, or any combination thereof. The processor 870 of a storage node 885 may execute computer-readable instructions stored in the memory 875 of the storage node 885 in order to cause the storage node 885 to perform processes described herein as performed by the storage node 885. A processor 870 may include one or more processing units, such as one or more CPUs, one or more GPUs, or any combination thereof. The memory 875 may comprise one or more types of memory (e.g., RAM, SRAM, DRAM, ROM, EEPROM, Flash, etc.). A disk 880 may include one or more HDDs, one or more SDDs, or any combination thereof. Memories 875 and disks 880 may comprise hardware storage devices. Collectively, the storage nodes 885 may in some cases be referred to as a storage cluster or as a cluster of storage nodes 885.

The DMS 810 may provide a backup and recovery service for the computing system 805. For example, the DMS 810 may manage the extraction and storage of snapshots 835 associated with different point-in-time versions of one or more target computing objects within the computing system 805. A snapshot 835 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 835 may also be used to restore (e.g., recover) the corresponding computing object as of the particular point in time corresponding to the snapshot 835. A computing object of which a snapshot 835 may be generated may be referred to as snappable. Snapshots 835 may be generated at different times (e.g., periodically or on some other scheduled or configured basis) in order to represent the state of the computing system 805 or aspects thereof as of those different times. In some examples, a snapshot 835 may include metadata that defines a state of the computing object as of a particular point in time. For example, a snapshot 835 may include metadata associated with (e.g., that defines a state of) some or all data blocks included in (e.g., stored by or otherwise included in) the computing object. Snapshots 835 (e.g., collectively) may capture changes in the data blocks over time. Snapshots 835 generated for the target computing objects within the computing system 805 may be stored in one or more storage locations (e.g., the disk 855, memory 850, the data storage device 830) of the computing system 805, in the alternative or in addition to being stored within the DMS 810, as described below.

To obtain a snapshot 835 of a target computing object associated with the computing system 805 (e.g., of the entirety of the computing system 805 or some portion thereof, such as one or more databases, virtual machines, or filesystems within the computing system 805), the DMS manager 890 may transmit a snapshot request to the computing system manager 860. In response to the snapshot request, the computing system manager 860 may set the target computing object into a frozen state (e.g., a read-only state). Setting the target computing object into a frozen state may allow a point-in-time snapshot 835 of the target computing object to be stored or transferred.

In some examples, the computing system 805 may generate the snapshot 835 based on the frozen state of the computing object. For example, the computing system 805 may execute an agent of the DMS 810 (e.g., the agent may be software installed at and executed by one or more servers 825), and the agent may cause the computing system 805 to generate the snapshot 835 and transfer the snapshot 835 to the DMS 810 in response to the request from the DMS 810. In some examples, the computing system manager 860 may cause the computing system 805 to transfer, to the DMS 810, data that represents the frozen state of the target computing object, and the DMS 810 may generate a snapshot 835 of the target computing object based on the corresponding data received from the computing system 805.

Once the DMS 810 receives, generates, or otherwise obtains a snapshot 835, the DMS 810 may store the snapshot 835 at one or more of the storage nodes 885. The DMS 810 may store a snapshot 835 at multiple storage nodes 885, for example, for improved reliability. Additionally, or alternatively, snapshots 835 may be stored in some other location connected with the network 820. For example, the DMS 810 may store more recent snapshots 835 at the storage nodes 885, and the DMS 810 may transfer less recent snapshots 835 via the network 820 to a cloud environment (which may include or be separate from the computing system 805) for storage at the cloud environment, a magnetic tape storage device, or another storage system separate from the DMS 810.

Updates made to a target computing object that has been set into a frozen state may be written by the computing system 805 to a separate file (e.g., an update file) or other entity within the computing system 805 while the target computing object is in the frozen state. After the snapshot 835 (or associated data) of the target computing object has been transferred to the DMS 810, the computing system manager 860 may release the target computing object from the frozen state, and any corresponding updates written to the separate file or other entity may be merged into the target computing object.

In response to a restore command (e.g., from a computing device 815 or the computing system 805), the DMS 810 may restore a target version (e.g., corresponding to a particular point in time) of a computing object based on a corresponding snapshot 835 of the computing object. In some examples, the corresponding snapshot 835 may be used to restore the target version based on data of the computing object as stored at the computing system 805 (e.g., based on information included in the corresponding snapshot 835 and other information stored at the computing system 805, the computing object may be restored to its state as of the particular point in time). Additionally, or alternatively, the corresponding snapshot 835 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 835. For example, the target version of the computing object may be restored based on the information in a snapshot 835 and based on information included in a backup copy of the target object generated prior to the time corresponding to the target version. Backup copies of the computing object may be stored at the DMS 810 (e.g., in the storage nodes 885) or in some other location connected with the network 820 (e.g., in a cloud environment, which in some cases may be separate from the computing system 805).

In some examples, the DMS 810 may restore the target version of the computing object and transfer the data of the restored computing object to the computing system 805. And in some examples, the DMS 810 may transfer one or more snapshots 835 to the computing system 805, and restoration of the target version of the computing object may occur at the computing system 805 (e.g., as managed by an agent of the DMS 810, where the agent may be installed and operate at the computing system 805).

In response to a mount command (e.g., from a computing device 815 or the computing system 805), the DMS 810 may instantiate data associated with a point-in-time version of a computing object based on a snapshot 835 corresponding to the computing object (e.g., along with data included in a backup copy of the computing object) and the point-in-time. The DMS 810 may then allow the computing system 805 to read or modify the instantiated data (e.g., without transferring the instantiated data to the computing system). In some examples, the DMS 810 may instantiate (e.g., virtually mount) some or all of the data associated with the point-in-time version of the computing object for access by the computing system 805, the DMS 810, or the computing device 815.

In some examples, the DMS 810 may store different types of snapshots 835, including for the same computing object. For example, the DMS 810 may store both base snapshots 835 and incremental snapshots 835. A base snapshot 835 may represent the entirety of the state of the corresponding computing object as of a point in time corresponding to the base snapshot 835. An incremental snapshot 835 may represent the changes to the state—which may be referred to as the delta—of the corresponding computing object that have occurred between an earlier or later point in time corresponding to another snapshot 835 (e.g., another base snapshot 835 or incremental snapshot 835) of the computing object and the incremental snapshot 835. In some cases, some incremental snapshots 835 may be forward-incremental snapshots 835 and other incremental snapshots 835 may be reverse-incremental snapshots 835. To generate a full snapshot 835 of a computing object using a forward-incremental snapshot 835, the information of the forward-incremental snapshot 835 may be combined with (e.g., applied to) the information of an earlier base snapshot 835 of the computing object along with the information of any intervening forward-incremental snapshots 835, where the earlier base snapshot 835 may include a base snapshot 835 and one or more reverse-incremental or forward-incremental snapshots 835. To generate a full snapshot 835 of a computing object using a reverse-incremental snapshot 835, the information of the reverse-incremental snapshot 835 may be combined with (e.g., applied to) the information of a later base snapshot 835 of the computing object along with the information of any intervening reverse-incremental snapshots 835.

In some examples, the DMS 810 may provide a data classification service, a malware detection service, a data transfer or replication service, backup verification service, or any combination thereof, among other possible data management services for data associated with the computing system 805. For example, the DMS 810 may analyze data included in one or more computing objects of the computing system 805, metadata for one or more computing objects of the computing system 805, or any combination thereof, and based on such analysis, the DMS 810 may identify locations within the computing system 805 that include data of one or more target data types (e.g., sensitive data, such as data subject to privacy regulations or otherwise of particular interest) and output related information (e.g., for display to a user via a computing device 815). Additionally, or alternatively, the DMS 810 may detect whether aspects of the computing system 805 have been impacted by malware (e.g., ransomware). Additionally, or alternatively, the DMS 810 may relocate data or create copies of data based on using one or more snapshots 835 to restore the associated computing object within its original location or at a new location (e.g., a new location within a different computing system 805). Additionally, or alternatively, the DMS 810 may analyze backup data to ensure that the underlying data (e.g., user data or metadata) has not been corrupted. The DMS 810 may perform such data classification, malware detection, data transfer or replication, or backup verification, for example, based on data included in snapshots 835 or backup copies of the computing system 805, rather than live contents of the computing system 805, which may beneficially avoid adversely affecting (e.g., infecting, loading, etc.) the computing system 805.

In some examples, the DMS 810, and in particular the DMS manager 890, may be referred to as a control plane. The control plane may manage tasks, such as storing data management data or performing restorations, among other possible examples. The control plane may be common to multiple customers or tenants of the DMS 810. For example, the computing system 805 may be associated with a first customer or tenant of the DMS 810, and the DMS 810 may similarly provide data management services for one or more other computing systems associated with one or more additional customers or tenants. In some examples, the control plane may be configured to manage the transfer of data management data (e.g., snapshots 835 associated with the computing system 805) to a cloud environment 895 (e.g., Microsoft Azure or Amazon Web Services). In addition, or as an alternative, to being configured to manage the transfer of data management data to the cloud environment 895, the control plane may be configured to transfer metadata for the data management data to the cloud environment 895. The metadata may be configured to facilitate storage of the stored data management data, the management of the stored management data, the processing of the stored management data, the restoration of the stored data management data, and the like.

Each customer or tenant of the DMS 810 may have a private data plane, where a data plane may include a location at which customer or tenant data is stored. For example, each private data plane for each customer or tenant may include a node cluster 896 across which data (e.g., data management data, metadata for data management data, etc.) for a customer or tenant is stored. Each node cluster 896 may include a node controller 897 which manages the nodes 898 of the node cluster 896. As an example, a node cluster 896 for one tenant or customer may be hosted on Microsoft Azure, and another node cluster 896 may be hosted on Amazon Web Services. In another example, multiple separate node clusters 896 for multiple different customers or tenants may be hosted on Microsoft Azure. Separating each customer or tenant's data into separate node clusters 896 provides fault isolation for the different customers or tenants and provides security by limiting access to data for each customer or tenant.

The control plane (e.g., the DMS 810, and specifically the DMS manager 890) manages tasks, such as storing backups or snapshots 835 or performing restorations, across the multiple node clusters 896. For example, as described herein, a node cluster 896-a may be associated with the first customer or tenant associated with the computing system 805. The DMS 810 may obtain (e.g., generate or receive) and transfer the snapshots 835 associated with the computing system 805 to the node cluster 896 a in accordance with a service level agreement for the first customer or tenant associated with the computing system 805. For example, a service level agreement may define backup and recovery parameters for a customer or tenant such as snapshot generation frequency, which computing objects to backup, where to store the snapshots 835 (e.g., which private data plane), and how long to retain snapshots 835. As described herein, the control plane may provide data management services for another computing system associated with another customer or tenant. For example, the control plane may generate and transfer snapshots 835 for another computing system associated with another customer or tenant to the node cluster 896 n in accordance with the service level agreement for the other customer or tenant.

To manage tasks, such as storing backups or snapshots 835 or performing restorations, across the multiple node clusters 896, the control plane (e.g., the DMS manager 890) may communicate with the node controllers 897 for the various node clusters via the network 820. For example, the control plane may exchange communications for backup and recovery tasks with the node controllers 897 in the form of transmission control protocol (TCP) packets via the network 820.

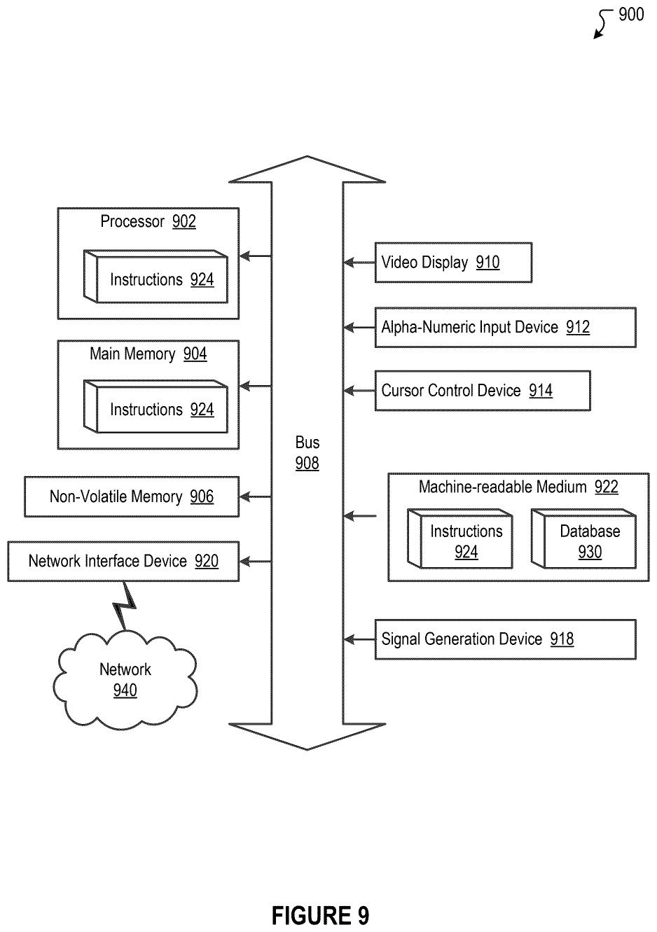

FIG. 9 illustrates an example of a computer system 900 that may be used to implement one or more of the embodiments of the present technology. For example, the computer system 900 can be implemented as a server, server system, or other type of computing system of the retrieval augmented generation (RAG) management system 102, the system 100, the data management service (DMS) 810, the computing system 805, the cloud environment 895, or the computing device 815. The computer system 900 can be included in a wide variety of local and remote machine and computer system architectures and in a wide variety of network and cloud computing environments that can implement the functionalities of the present technology. The computer system 900 includes sets of instructions 924 for causing the computer system 900 to perform the functionality, features, and operations discussed herein. The computer system 900 may be connected (e.g., networked) to other machines and/or computer systems. In a networked deployment, the computer system 900 may operate in the capacity of a server or a client machine in a client-server network environment, or as a peer machine in a peer-to-peer (or distributed) network environment.

The computer system 900 includes a processor 902 (e.g., a central processing unit (CPU), a graphics processing unit (GPU), or both), a main memory 904, and a nonvolatile memory 906 (e.g., volatile RAM and non-volatile RAM, respectively), which communicate with each other via a bus 908. In some embodiments, the computer system 900 can be a desktop computer, a laptop computer, personal digital assistant (PDA), or mobile phone, for example. In one embodiment, the computer system 900 also includes a video display 910, an alphanumeric input device 912 (e.g., a keyboard), a cursor control device 914 (e.g., a mouse), a signal generation device 918 (e.g., a speaker) and a network interface device 920.

In one embodiment, the video display 910 includes a touch sensitive screen for user input. In one embodiment, the touch sensitive screen is used instead of a keyboard and mouse. A machine-readable medium 922 can store one or more sets of instructions 924 (e.g., software) embodying any one or more of the methodologies, functions, or operations described herein. The instructions 924 can also reside, completely or at least partially, within the main memory 904 and/or within the processor 902 during execution thereof by the computer system 900. The instructions 924 can further be transmitted or received over a network 940 via the network interface device 920. In some embodiments, the machine-readable medium 922 also includes a database 930.

The processor 902 can be, for example, a hardware based integrated circuit (IC) or any other suitable processing device configured to run or execute a set of instructions or a set of codes. For example, the processor 902 can include a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like.

The network 940, which can represent the network 820, can be, for example, a digital telecommunication network of servers and/or computing devices. The servers and/or computing device on the network can be connected via one or more wired or wireless communication networks (not shown) to share resources such as, for example, data storage and/or computing power. The wired or wireless communication networks between servers and/or computing devices of the network can include one or more communication channels, for example, a radio frequency (RF) communication channel(s), an extremely low frequency (ELF) communication channel(s), an ultra-low frequency (ULF) communication channel(s), a low frequency (LF) communication channel(s), a medium frequency (MF) communication channel(s), an ultra-high frequency (UHF) communication channel(s), an extremely high frequency (EHF) communication channel(s), a fiber optic communication channel(s), an electronic communication channel(s), a satellite communication channel(s), and/or the like. The network can be, for example, the Internet, an intranet, a local area network (LAN), a wide area network (WAN), a metropolitan area network (MAN), a worldwide interoperability for microwave access network (WiMAX®), any other suitable communication system, and/or a combination of such networks.

The network 940 can use standard communications technologies and protocols. Thus, the network can include links using technologies such as Ethernet, 902.11, worldwide interoperability for microwave access (WiMAX®), 3G, 4G, 5G, CDMA, GSM, LTE, digital subscriber line (DSL), etc. Similarly, the networking protocols used on the network can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 906 may also be a random access memory. The non-volatile memory 906 can be a local device coupled directly to the rest of the components in the computer system 900. A non-volatile memory that is remote from the system, such as a network storage device coupled to any of the computer systems described herein through a network interface such as a modem or Ethernet interface, can also be used.

While the machine-readable medium 922 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 900 to perform any one or more of the processes and features described herein.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 900 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in the same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine or computer-readable media used to actually affect the distribution.

Some embodiments described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java™, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java™, C++, etc.) or other suitable programming languages and/or development tools. Additional examples of computer code include, but are not limited to, control signals, encrypted code, and compressed code.

For purposes of explanation, numerous specific details are set forth in order to provide a thorough understanding of the description. It will be apparent, however, to one skilled in the art that embodiments of the present technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in some embodiments,” “in various embodiments,” “in an example,” “in one implementation,” “in one instance,” “in some instances,” or the like means that a particular feature, design, structure, or characteristic described in connection with the embodiment is included in at least one embodiment of the present technology. The appearances of, for example, the phrases “according to an embodiment,” “in one embodiment,” “in an embodiment,” “in some embodiments,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in method, computer readable medium, and apparatus modes.

Further, each of the various elements of the invention and claims may also be achieved in a variety of manners. This technology should be understood to encompass each such variation, be it a variation of an embodiment of any apparatus (or system) embodiment, a method or process embodiment, a computer readable medium embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the present technology of the embodiments of the invention is intended to be illustrative, but not limiting, of the scope of the invention, which is set forth in the following claims.

1. A computer-implemented method comprising:
based on an embedding model, generating, by a computing system, an embedding vector based on a chunk of a document;
providing, by the computing system, for storage in a vector database i) the embedding vector and a dimension and ii) a second embedding vector, the dimension, and a second dimension,
wherein
the dimension and the second dimension are included in a nested hierarchy of dimensions associated with the document,
the dimension is descriptive of the entirety of the document and the second dimension is descriptive of a portion of the document,
the embedding vector is associated with the dimension,
the second embedding vector is generated based on a second chunk of the portion of the document and associated with the dimension and the second dimension,
the embedding vector is stored in a column of a table of the vector database, and
the dimension is stored in a metadata column of the table adjacent to the column;
and
based on a query, causing, by the computing system, a search of the vector database including the embedding vector and the second embedding vector, wherein the search is based at least in part on i) the embedding vector and the dimension and ii) the second embedding vector, the dimension, and the second dimension.

2. The computer-implemented method of claim 1, wherein the dimension is a key-value pair.

3. (canceled)

4. (canceled)

5. The computer-implemented method of claim 1, wherein the dimension is included in a set of dimensions determined based at least in part on a schema associated with a type of the document.

6. The computer-implemented method of claim 1, wherein the dimension is excluded from chunking of the document.

7. The computer-implemented method of claim 1, wherein
the embedding vector is not associated with the second dimension.

8. The computer-implemented method of claim 1, further comprising:
transforming the query into a query portion and a metadata filter portion,
wherein the search of a vector database including the embedding vector and the second embedding vector is based at least in part on the metadata filter portion.

9. The computer-implemented method of claim 8, wherein the transforming is performed by a large language model (LLM).

10. The computer-implemented method of claim 1, wherein
the document is a type associated with a software-as-a-service (Saas) application, and
the embedding vector and associated dimension are stored in a vector database supportive of a retrieval augmented generation (RAG) system.

11. A system comprising:
at least one processor; and
a memory storing instructions that, when executed by the at least one processor, cause the system to perform operations comprising:
based on an embedding model, generating an embedding vector based on a chunk of a document;
providing for storage in a vector database i) the embedding vector and a dimension and ii) a second embedding vector, the dimension, and the second dimension,
wherein
the dimension and the second dimension are included in a nested hierarchy of dimensions associated with the document,
the dimension is descriptive of the entirety of the document and the second dimension is descriptive of a portion of the document,
the embedding vector is associated with the dimension,
the second embedding vector is generated based on a second chunk of the portion of the document and associated with the dimension and the second dimension,
the embedding vector is stored in a column of a table of the vector database, and
the associated dimension is stored in a metadata column of the table adjacent to the column;
and
based on a query, causing a search of the vector database including the embedding vector and the second embedding vector, wherein the search is based at least in part on i) the embedding vector and the dimension and ii) the second embedding vector, the dimension, and the second dimension.

12. The system of claim 11, wherein the dimension is a key-value pair.

13. (canceled)

14. (canceled)

15. The system of claim 11, wherein the dimension is included in a set of dimensions determined based at least in part on a schema associated with a type of the document.

16. A non-transitory computer-readable storage medium including instructions that, when executed by at least on processor of a computing system, cause the computing system to perform operations comprising:
based on an embedding model, generating an embedding vector based on a chunk of a document;
providing for storage in a vector database i) the embedding vector and a dimension and ii) a second embedding vector, the dimension, and a second dimension.
wherein
the dimension and the second dimension are included in a nested hierarchy of dimensions associated with the document,
the dimension is descriptive of the entirety of the document and the second dimension is descriptive of a portion of the document,
the embedding vector is associated with the dimension,
the second embedding vector is generated based on a second chunk of the portion of the document and associated with the dimension and the second dimension,
the embedding vector is stored in a column of a table of the vector database, and
the associated dimension is stored in a metadata column of the table adjacent to the column;
and
based on a query, causing a search of the vector database including the embedding vector and the second embedding vector, wherein the search is based at least in part on i) the embedding vector and the dimension and ii) the second embedding vector, the dimension, and the second dimension.

17. The non-transitory computer-readable storage medium of claim 16, wherein the dimension is a key-value pair.

18. (canceled)

19. (canceled)

20. The non-transitory computer-readable storage medium of claim 16, wherein the dimension is included in a set of dimensions determined based at least in part on a schema associated with a type of the document.

21. The system of claim 11, wherein the dimension is excluded from chunking of the document.

22. The system of claim 11, wherein
the embedding vector is not associated with the second dimension.

23. The system of claim 11, further comprising:
transforming the query into a query portion and a metadata filter portion,
wherein the search of a vector database including the embedding vector and the second embedding vector is based at least in part on the metadata filter portion.

24. The non-transitory computer-readable storage medium of claim 16, wherein the dimension is excluded from chunking of the document.

25. The non-transitory computer-readable storage medium of claim 16, wherein
the embedding vector is not associated with the second dimension.

26. The non-transitory computer-readable storage medium of claim 16, wherein the operations further comprise:
transforming the query into a query portion and a metadata filter portion,
wherein the search of a vector database including the embedding vector and the second embedding vector is based at least in part on the metadata filter portion.
